(19) United States
(12) Patent Application Publication
(10) Pub. No.: US 2024/0381841 A1
(43) Pub. Date: Nov. 21, 2024

(54) CAT DETTERENT SYSTEM

(71) Applicants: David Klatt, New Castle, WA (US); Susan Klatt, New Castle, WA (US)

(72) Inventors: David Klatt, New Castle, WA (US); Susan Klatt, New Castle, WA (US)

(21) Appl. No.: 18/198,678

(22) Filed: May 17, 2023

(51) Int. Cl. A01K 15/02; A01M 29/16

(52) U.S. Cl. CPC A01K 15/02; A01M 29/16

(57) ABSTRACT

A cat deterrent kit, system, and method of deterring a domesticated house cat from entering a restricted area or engaging in an unwanted behavior are disclosed. The cat deterrent kit contains a cylindrical spray bottle, first and second puck-shaped rattlers, and an elastic sleave sized and configured to detachably connect the bottom section of the spray bottle to the first or second rattlers. In some embodiments, the puck-shaped rattlers comprise a plurality of small spherical beads contained within a chamber, and may optionally include an outer magnet that allows magnetic attachment of the rattlers to certain metal surfaces (such as, for example, a refrigerator door or other steel objects). In the method of the invention, a cat is deterred by spraying the spray bottle while simultaneously shaking the rattler to thereby spray the cat with water while the cat is entering the restricted area or engaging in the unwanted behavior.

### TECHNICAL FIELD

The present invention relates generally to animal training devices and, more particularly, to devices and systems for deterring cats from entering into restricted areas and/or engaging in unwanted behaviors.

### BACKGROUND OF THE INVENTION

Generally speaking, cats love to wander and explore their environment while cat owners love their cats. There are, however, certain areas and objects within a home that owners of domesticated cats desire to keep their feline friends away from—whether it's to protect furniture or house plants from unwanted harm caused by their cats, or to protect their cats from leaving the sanctuary of their homes. To curb certain unwanted behaviors and wandering by domesticated cats, cat owners often resort to the use of various mechanical and chemical cat repellants.

Cat repellents use a variety of mechanisms—such as, for example, bitter scents, unpleasant textures, water sprays—to keep cats out of restricted areas or away from certain household objects (such as, for example, furniture and house plants). Cat repellents are also known to be useful in deterring feral or neighborhood cats from entering restricted yards and flower gardens. For example, expensive sonic, ultrasonic and motion-activated cat deterrent systems have been developed to keep cats out of no-go areas. The use of cat repellents alone, however, does not always adequately condition or train cats to obey the desires of their owners over extended periods of time.

Consequently, and although some progress has been made over the years with respect to cat deterrent systems, there is still a need in the art for new and improved devices, systems and methods for deterring cats from entering into restricted areas or engaging in unwanted behaviors. The present invention fulfills these needs and provides for further related advantages.

### SUMMARY OF THE INVENTION

In brief, the present invention in an embodiment is directed to, in combination, a cat deterrent device that comprises an upper spray bottle connected to a lower puck-shaped rattler by means of a surrounding elastic sleave. The spray bottle contains ordinary water. The rattler preferable has the shape of a hollow cylindrical puck and contains a plurality of beads (that cause a rattling sound when shaken). In another embodiment, the invention is directed to a method of deterring a cat from entering into a restricted area or engaging in an unwanted behavior. The method involves first spraying the spray bottle while simultaneously shaking the rattler to thereby spray a subject cat with water while the cat is contemplating entering a restricted area or engaging in an unwanted behavior to thereby deter the cat, and second, shaking only the rattler within hearing range of the cat (with no spraying of the spray bottle) while the cat is contemplating entering into the restricted area or engaging in the unwanted behavior to thereby deter the cat (through the association made between the sensation of the negative spray and the concurrent rattling sound in the cat's mind). In still another embodiment, the invention is directed to a cat deterrent kit for deterring a cat from entering into a restricted area or engaging in unwanted behavior, wherein the kit contains a spray bottle, a plurality of puck-shaped rattlers, a connection sleave, and an instructional pamphlet (that describes a training method of deterring a cat from entering into a restricted area or engaging in an unwanted behavior).

These and other aspects of the present invention will become more evident upon reference to the following detailed description and accompanying drawings. It is to be understood, however, that various changes, alterations, and substitutions may be made to the specific embodiments disclosed herein without departing from their essential spirit or scope.

### BRIEF DESCRIPTION OF THE DRAWINGS

The drawings are intended to be illustrative of certain preferred and exemplary embodiments of the present invention and, thus, may not necessarily be drawn to scale. In addition, like reference numerals have been used to designate like parts and features shown throughout the several views of the drawings.

FIG. 1 is a front view of a first cat deterrent device that comprises an upper spray bottle connected to a lower puck-shaped rattler by means of a surrounding elastic sleave in accordance with an embodiment of the present invention.

FIG. 2 is a top plan view of a second cat deterrent device that comprises of a puck-shaped rattler in accordance with an embodiment of the present invention.

FIG. 3 is a front cross-sectional of the first cat deterrent device shown in FIG. 1.

FIG. 4 is a side cross-sectional view of the second cat deterrent device shown in FIG. 2.

FIG. 5 is an illustration of a hand spraying the spray bottle while simultaneously shaking the rattler (of the cat deterrent device shown in FIG. 1) to thereby spray the cat (not shown) with liquid water while the cat is contemplating entering into a restricted area or engaging in an unwanted behavior.

FIG. 6 is an illustration of a cat deterrent system and kit in accordance with an embodiment of the present invention.

FIG. 7 is a partially transparent illustration of a cat owner shaking a puck-shaped rattler on the far side of a closed door to thereby deter her cat from trying to escape out through the doorway (and into a restricted area) in accordance with an embodiment of the present invention.

FIG. 8 is an illustration of a cat owner shaking a puck-shaped rattler at a curious cat that is contemplating jumping up on a countertop (an unwanted behavior) to thereby deter the cat in accordance with an embodiment of the present invention.

FIG. 9 is block diagram showing the different steps associated with a method of deterring a cat from entering into a restricted area or engaging in an unwanted behavior in accordance with an embodiment of the present invention.

### DETAILED DESCRIPTION OF INVENTION

The present invention may be understood more readily by reference to the following detailed description of certain preferred and exemplary embodiments of the invention in view of the accompanying drawings. It is to be understood that the terminology used herein is for the purpose of describing specific embodiments only and is not intended to be limiting. It is to be further understood that unless specifically defined herein, the terminology used herein is to be given its conventional meaning as understood in the relevant art. Any headings used within this document are only being utilized to expedite its review by the reader, and should not be construed as limiting the claimed invention in any manner.

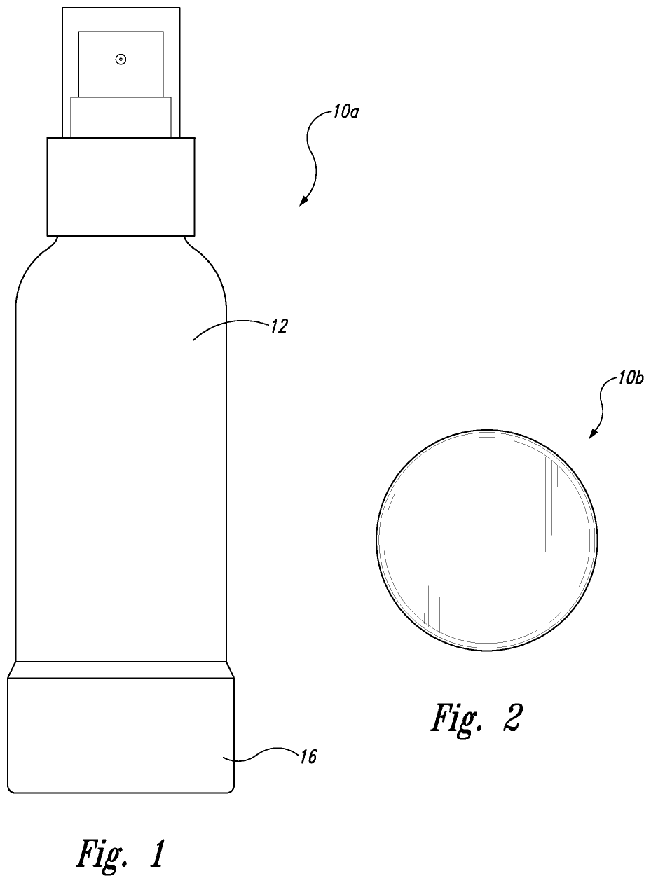

Referring now to FIGS. 1-6, the present invention in a first embodiment is directed to a cat deterrent system 10 (see FIG. 6) configured to deter a cat from entering into a restricted area (such as, for example, going beyond the boundaries of a doorway that leads to a forbidden outside area) or engaging in an unwanted behavior (such as, for example, jumping up on a countertop). The cat deterrent system 10 consist essentially of two parts; namely, first and second cat deterrent devices 10a, 10b (that are preferably bundled together in the form of a kit).

As shown, the first cat deterrent device 10a comprises an upper cylindrical spray bottle 12 connected to a lower puck-shaped rattler 14 by means of a surrounding sleave 16. The sleave 16 is preferably made of rubber or a rubber-like material to thereby facilitate its detachably connectability and secure friction fit between the upper spray bottle 12 and the lower puck-shaped rattler 14. In the second cat deterrent device 10b, a disc-shaped magnet 20 is affixed to one side of the puck-shaped rattler 14 (and encased by rubber or a rubber-like material) thereby allowing magnetic attachment of the rattler 14 to certain metal surfaces (not shown) such as, for example, a refrigerator door or other steel objects.

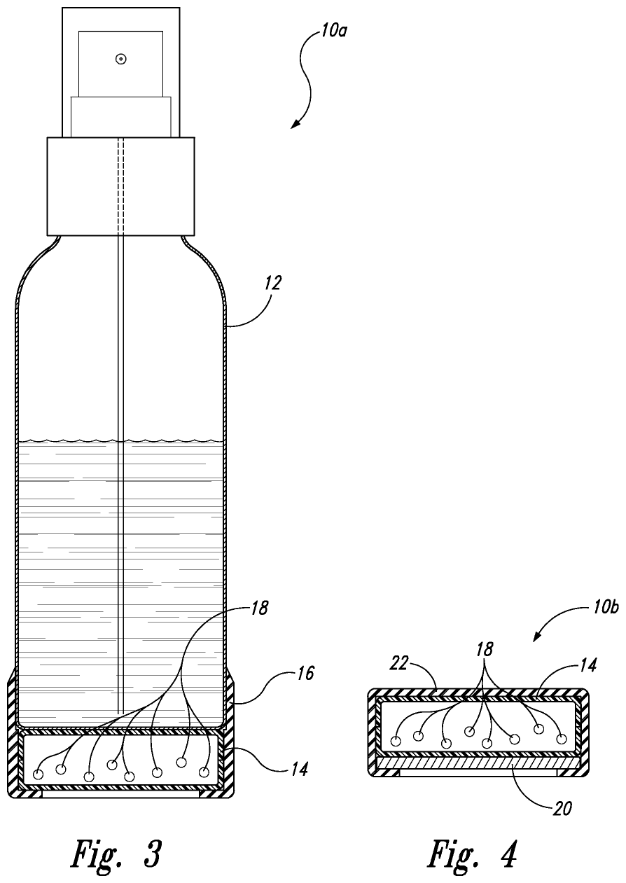

As best shown in FIGS. 3-4, the puck-shaped rattler 14 component of the cat deterrent device 10 is generally hollow (and thus defines a chamber) and contains a plurality of spherical beads 18 contained within the chamber. In this configuration, the forceful shaking of the rattler 14 results in the emission of a rattling sound from the rattler 14 that can be heard over some distance by both humans and cats alike.

In the practice of the invention (as more fully described below), the simultaneous spraying of a cat that is contemplating (or appears to be contemplating as is appreciated by owners of domesticated house cats) entering into a restricted/forbidden area or engaging in an unwanted activity while simultaneously shaking the rattler creates an association in the cat's mind between the two. Without necessarily prescribing to any particular scientific theory, it is believed that spraying a liquid at a cat who is about to misbehave causes an undesirable negative sensation in the cat's mind that the cat wishes to avoid (by not misbehaving in the future). Because the cat associates the rattling sound with an undesirable negative sensation and after some period of training, the rattling sound alone is able to deter the cat from misbehaving. In this way, a cat's owner can train or condition his or her cat to not engage in forbidden activities or not enter into restricted areas.

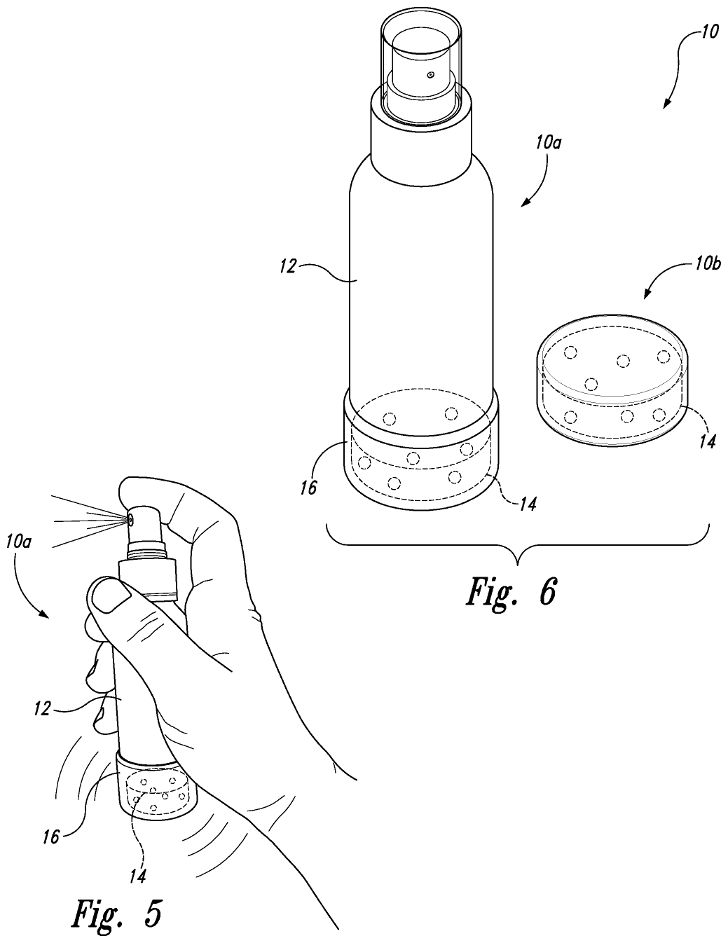

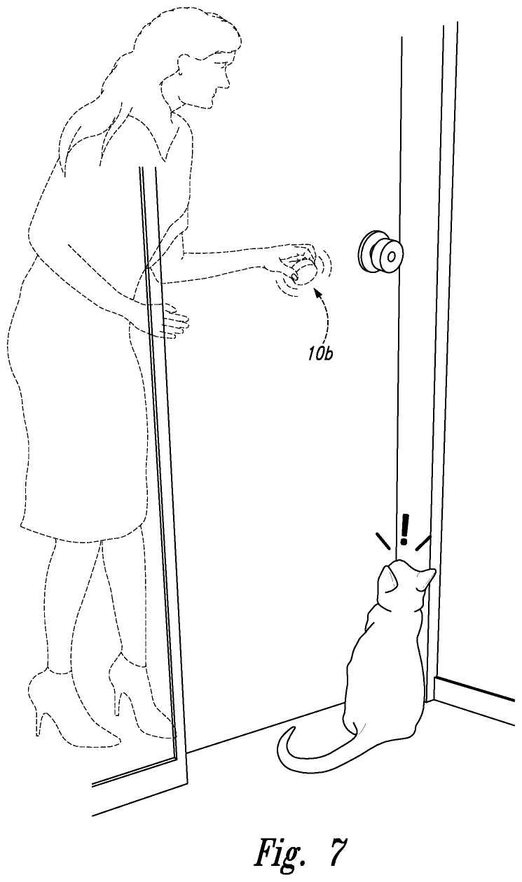

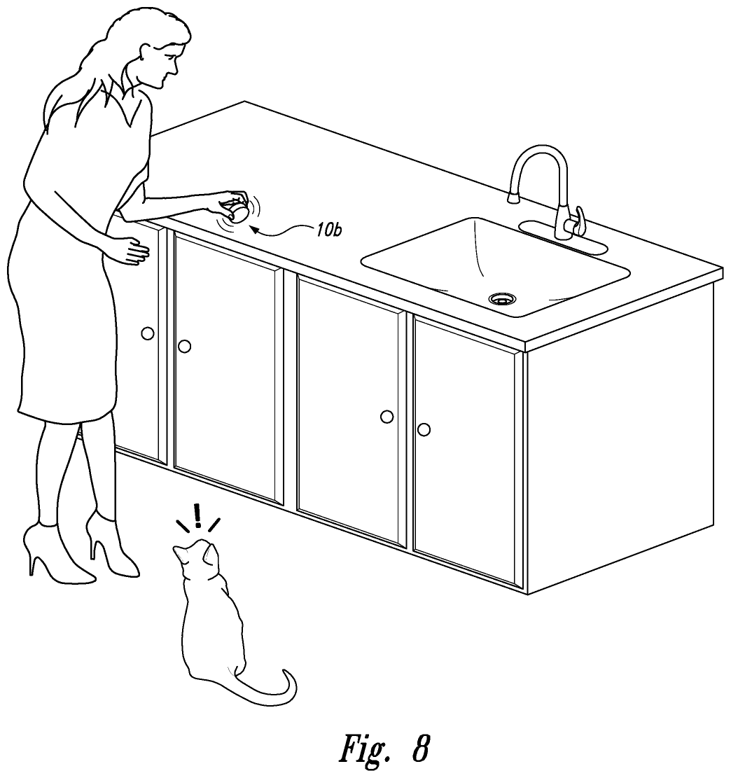

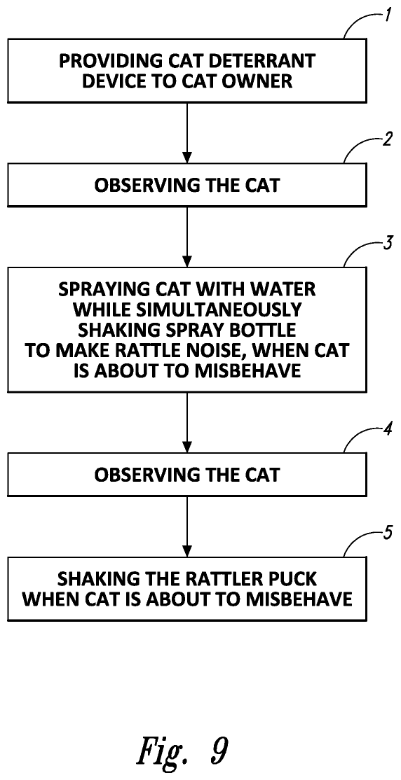

Referring now to FIGS. 5-9, the present invention in another embodiment is directed to a method of deterring a cat from entering into a restricted area or engaging in an unwanted behavior. As illustrated in the block diagram of FIG. 9, the method comprises the following steps: (1) providing a spray bottle that has a rattler attached to the spray bottle, wherein the rattler comprises a plurality of beads contained within a chamber and the spray bottle contains a selected liquid; (2) observing the behavior of the cat over a first period of time; (3) spraying the spray bottle while simultaneously shaking the bottle and rattler to thereby spray the cat with liquid while the cat is entering the restricted area or engaging in the unwanted behavior to thereby deter the cat; (4) observing the behavior of the cat over a second period of time; and (5) shaking the rattler within hearing range of the cat while the cat is entering the restricted area or engaging in the unwanted behavior to thereby deter the cat.

In still another embodiment (and as best shown, in part, in FIG. 6), the present invention is directed to a cat deterrent kit that comprises a spray bottle 12, a plurality of puck-shaped rattlers 14, a connection sleave 16, and an instructional pamphlet that describes a training method of deterring a cat from entering a restricted area or engaging in an unwanted behavior (not shown). The cat deterrent kit will be sold in commerce to cat owner's desirous of deterring their cats from doing misdeeds around the house and/or leaving designated areas.

While the present invention has been described in the context of the embodiments described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A cat deterrent device, comprising:
a spray bottle having a top section and a bottom section; and
a first rattler detachably attached to the bottom section of the spray bottle.

2. The cat deterrent device of claim 1, further comprising liquid water contained within the spray bottle, and wherein the first rattler comprises a plurality of beads contained within a chamber.

3. The cat deterrent device of claim 2 wherein the beads are spherical.

4. The cat deterrent device of claim 2 wherein the spray bottle is cylindrical and the first rattler has the shape of a hollow cylindrical puck.

5. The cat deterrent device of claim 4, further comprising an outer cylindrical sleeve sized and configured to receive the bottom section of the cylindrical spray bottle and the first rattler.

6. The cat deterrent device of claim 5 wherein the cylindrical sleeve is made of rubber or a rubber-like material.

7. The cat deterrent device of claim 6 wherein the first rattler further comprises an attachment means.

8. The cat deterrent device of claim 7 wherein the attachment means is a magnet.

9. A method of deterring a cat from entering into a restricted area or engaging in an unwanted behavior, the method comprising the steps of:
providing a spray bottle that has a first rattler attached to the spray bottle, wherein the first rattler comprises a plurality of beads contained within a chamber and the spray bottle contains liquid water;
observing the behavior of the cat over a first period of time;
spraying the spray bottle while simultaneously shaking the rattler to thereby spray the cat with liquid while the cat is entering the restricted area or engaging in the unwanted behavior to thereby deter the cat;
observing the behavior of the cat over a second period of time; and
shaking the first rattler or a second rattler within hearing range of the cat while the cat is entering the restricted area or engaging in the unwanted behavior to thereby deter the cat.

10. The method of claim 9 wherein the beads are spherical.

11. The method of claim 10 wherein the spray bottle is cylindrical and the first rattler has the shape of a hollow cylindrical puck.

12. A cat deterrent kit for deterring a cat from entering a restricted area or engaging in unwanted behavior, comprising:
a spray bottle having a first rattler detachably attached to the bottom section of the spray bottle; and
a second rattler.

13. The cat deterrent kit of claim 12 wherein the first and second rattler each comprises a plurality of beads contained within a chamber.

14. The cat deterrent kit of claim 13 wherein the spray bottle is cylindrical and the first and second rattler each has the shape of a hollow cylindrical puck.

15. The cat deterrent kit of claim 14, further comprising an outer cylindrical sleeve sized and configured to receive the bottom section of the cylindrical spray bottle and the first or second cylindrical rattler.

16. The cat deterrent kit of claim 15 wherein the cylindrical sleeve is made of rubber or a rubber-like material.

17. The cat deterrent kit of claim 16 wherein the first and second rattlers each further comprise an attachment means.

18. The cat deterrent kit of claim 17 wherein the attachment means is a magnet.

19. The cat deterrent kit of claim 18, further comprising an instructional pamphlet that describes a method of deterring a cat from entering a restricted area or engaging in an unwanted behavior.
